(19) United States
(12) Patent Application Publication
(10) Pub. No.: US 2008/0304287 A1
(43) Pub. Date: Dec. 11, 2008

(54) Microstructure transfer medium and application thereof

(75) Inventors: Whe Yi Chiang, Hsinchu City (TW); Ta Ching Pong, Hsinchu City (TW)

Correspondence Address: Joe McKinney Muncy, PO Box 1364, Fairfax, VA, 22038-1364, US

(73) Assignee: Lentics Corporation

(21) Appl. No.: 11/808,392

(22) Filed: Jun. 8, 2007

(51) Int. Cl. F21V 8/00; F21V 5/02; F21V 5/04

(52) U.S. Cl. 362/618; 362/333; 362/335; 362/339; 427/595; 428/515

(57) ABSTRACT

The present invention discloses a microstructure transfer medium and application thereof to produce various microstructures on a film, glass substrate, plastic substrate, etc. for utilization in a variety of optical films of a backlight module, light guide plates, color enhancement film for liquid crystal displays, various patterned nanoimprint for semiconductor or flat panel display processes, and Fresnel lens. Furthermore, the microstructure transfer medium according to the present invention can be applied in producing microstructures on a non-planar surface. The microstructure transfer medium according to the present invention comprises a substrate and a release layer formed on the substrate wherein the release layer has microstructures thereon. Preferably, the surface energy of the release layer is lower than 30 dyne/cm.

### BACKGROUND OF THE INVENTION

1. Field of the Invention

The present invention is generally related to a microstructure transfer medium and application thereof, and more particularly to a microstructure transfer medium applied in a variety of optical films of a backlight module, light guide plates, color enhancement film for liquid crystal displays, various patterned nanoimprint for semiconductor or flat panel display processes, and Fresnel lens.

2. Description of the Prior Art

Microstructure films have been extensively applied in various areas, such as lighting, advertising lighting boxes, backlights, and displays.

In backlight modules, the optical members with microstructures, such as brightness enhancement film and light guide plate, are usually made by firstly preparing a metallic mold with microstructures and then setting the resin in the metallic mold via an ultraviolet curing or injection molding method.

However, for example of fabricating brightness enhancement films, a mold processed by diamond turning and an ultraviolet curable resin are used to form the brightness enhancement film. Not only is the cost of fabricating the mold high but also is the wear of the mold due to resin residue, mechanical wear, or reaction between the mold and the resin is fast. Besides, the ultraviolet curable resin has to be specially optimized to fulfill various physical and chemical properties, such as optical characteristics and heat resistance. Furthermore, when the microstructure to be formed has sharp angles or has a large aspect ratio (that is, the height to the width ratio is more than 1), such as prism or Fresnel lens, defects may occur at the sharp vertex or mold releasing imperfection may occur, during separating the mold from the film in the process of fabricating the microstructure film. Part of the cured resin is left on the mold or the resin reacts with the metallic mold to cause the problems of a low production yield, short lifetime of the mold, and high cost.

Besides, the ultraviolet curable resin used to fabricate the microstructure film usually comprise release compositions in order to be able to release from the metallic surface to prevent the resin residue on the mold. However, sometimes it is difficult to have the ultraviolet curable resin fulfill all of the various required characteristics simultaneously. That is, the resin residue problem is still existed even though the release composition is added.

In the process of fabricating the light guide plate, by the injection molding method, a pattern with hemi-sphere structures is formed on the surface opposing to the light exiting surface of the light guide plate, together with the light guide plate itself. The size and shape of the microstructure are limited by the capability of the injection molding machine. In addition, accompanying with the size increase of the light guide plate, the casting method is used instead of the injection molding method. The pattern on the surface opposing to the light exiting surface of the light guide plate is then printed on a planar polymethyl methacrylate plate, instead of injection molding with stencil. However, the printing method generally produces a two-dimensional pattern but not three-dimensional structure. Moreover, in order to promote the functionality of the light guide plate, forming various microstructures on the two surfaces, the surface opposing to the light exiting surface and the light exiting surface, has been currently extensively researched. However, it is not extensively utilized due to many problems on the fabrication and high cost.

Furthermore, fabricating a microstructure film with size smaller than 20 μm or a complicate structure is even more difficult as well as has high cost. These factors limit the application of the microstructure film. For example, it is important to control cost for the microstructure film utilized in lighting or an advertising lighting box to smear the shape of the light source.

To solve the above-mentioned problems associated with the microstructure film, a new approach to fabricate a microstructure film is still needed corresponding to both economic effect and utilization in industry.

### SUMMARY OF THE INVENTION

In accordance with the present invention, a microstructure transfer medium is provided to fabricate a microstructure film. The microstructure transfer medium comprises a substrate and a release layer formed on the substrate. The release layer has microstructures thereon. Preferably, the surface energy of the release layer is lower than 30 dyne/cm. More preferably, the surface energy of the release layer is lower than 25 dyne/cm. Therefore, the surface of the microstructure film is very easy to be released from the metallic surface. Besides, it is also very easy to be released from the material having the surface with the surface energy higher than 30 dyne/cm. Thus, during fabricating a microstructure film, the problems of defects at the sharp vertex or mold releasing imperfection are not existed. Furthermore, the cost of the microstructure transfer medium is low.

One object of the present invention is to provide a microstructure transfer medium to fabricate a microstructure film. Additionally, another object of the present invention is to provide a method for fabricating a microstructure transfer medium. The method comprises the following steps: providing a substrate; providing a mold having a template of the microstructure on the surface thereof; coating a release resin on the substrate; pressing the mold into the substrate having the release resin thereon and setting the release resin; and separating the mold from the substrate to form the microstructure transfer medium.

Preferably, the release layer is formed by the substance with low surface energy selected from a group consisting of the following: silicone resin, fluorine-containing resin, and polyolefin resin. The release resin is an ultraviolet curable resin or thermoplastic resin.

In one embodiment of the invention, the microstructure film, fabricated by using the microstructure transfer medium according to the present invention, comprises a first substrate having a first surface and a second surface and a plurality of first microstructures formed on the first surface of the first substrate and made by using a first microstructure transfer medium. The first microstructure transfer medium comprises a second substrate and a release layer formed on the second substrate and the release layer has a template of the first microstructures thereon. The template has the hollow structure that used to form the first microstructures.

Furthermore, a plurality of second microstructures can be formed on the second surface of the first substrate by using a second microstructure transfer medium. The second microstructure transfer medium comprises a second substrate and a release layer formed on the second substrate and the release layer has a template of the second microstructures thereon.

In addition, in another embodiment of the invention, the microstructure film, fabricated by using the microstructure transfer medium according to the present invention, comprises a first substrate having a first surface and a second surface; and a plurality of first microstructures formed on the first surface of the first substrate and made by using a mold that is a laminate of a first microstructure transfer medium and a film having a plurality of third microstructures thereon. The first microstructure transfer medium comprises a second substrate and a release layer formed on the second substrate and the release layer has a plurality of second microstructures thereon. The method of using the mold to form the first microstructures comprises: overlapping the first microstructure transfer medium and the film having a plurality of third microstructures thereon to form the mold; coating a resin on the first substrate; and pressing the mold into the first substrate coated with the resin and curing the resin to form the microstructure film. Preferably, the second substrate is a flexible film. The first microstructures comprise the third microstructures and the second microstructures.

Accordingly, the present invention discloses a microstructure transfer medium to be utilized in fabricating various microstructure films. The microstructure transfer medium can be applied in manufacturing a variety of optical films of a backlight module, light guide plates, color enhancement film for liquid crystal displays, various patterned nanoimprint for semiconductor or flat panel display processes, and Fresnel lens.

### BRIEF DESCRIPTION OF THE DRAWINGS

FIG. 1 shows the cross-sectional diagrams of the microstructures 101A, 201A, 301A on the microstructure transfer media and the microstructures 101B, 201B, 301B on the microstructure films fabricated by using the microstructures 101A, 201A, 301A on the microstructure transfer media, respectively.

### DESCRIPTION OF THE PREFERRED EMBODIMENTS

What is probed into the invention is a microstructure transfer medium. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

The microstructure transfer medium according to the invention is fabricated by forming a microstructure layer on a substrate, such as a film, sheet, or plate. The microstructure transfer medium comprises a substrate and a release layer formed on the substrate. The release layer has microstructures thereon.

The substrate is a film, sheet, or plate formed by the substance selected from a group consisting of the following: polyethylene terephthalate, polybutylene terephthalate, polyethylene naphthalate, polycarbonate, polyethylene, polypropylene, polystyrene, triacetyl cellulose, acrylate, methacrylate, and polyethylene chloride. Preferably, the surface of the substrate is treated with corona or coated with an adhesion promoter. The thickness of the substrate for the microstructure transfer medium generally is about 20˜400 μm. Practically, the lower limit of the thickness is 50 μm.

Preferably, the surface energy of the release layer is lower than 30 dyne/cm. More preferably, the surface energy of the release layer is lower than 25 dyne/cm. By such low surface energy, it is easy to separate the mold from the microstructure transfer medium in the process of fabricating the microstructure transfer medium and to separate the microstructure transfer medium from the microstructure film in the process of fabricating the microstructure film. Preferably, the release layer is formed by the substance with low surface energy selected from a group consisting of the following: silicone resin, fluorine-containing resin, and polyolefin resin.

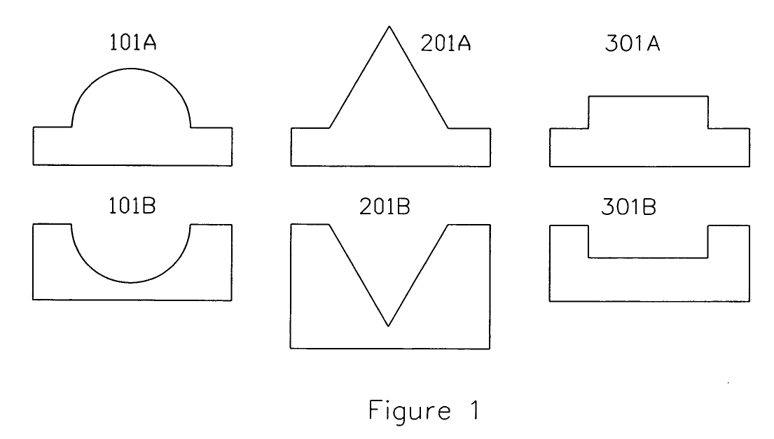

The microstructure is a hollow structure and can be used to form the structure selected from a group consisting of the following: sphere, hemi-sphere, hemi-cylinder, prism, pyramid and the combination thereof. That is to say, the microstructure is a template of the structures, such as sphere, hemi-sphere, hemi-cylinder, prism, pyramid and the combination thereof. The microstructure forms a linear-, matrix-, or random-type three-dimensional pattern on the surface of the release layer. For example, FIG. 1 shows the microstructures 101A, 201A, 301A on the microstructure transfer media and the microstructures 101B, 201B, 301B on the microstructure films fabricated by using the microstructures 101A, 201A, 301A on the microstructure transfer media, respectively.

According to the invention, the method for manufacturing a microstructure transfer medium, comprising the following steps: providing a substrate; providing a mold having a template of the microstructure on the surface thereof; coating a release resin on the substrate; pressing the mold into the substrate having the release resin thereon and setting the release resin; and separating the mold from the substrate to form the microstructure transfer medium.

The release resin is an ultraviolet curable resin or thermoplastic resin. The method for setting the release resin comprises ultraviolet curing or thermopressing. The mold used in the method for manufacturing a microstructure transfer medium is made of metals or plastics. The mold can be a photo-mask made by photolithography or laser ablation. The mold can also be made of metals and produced by precision diamond turning or electroplating/electroforming. Moreover, the mold can be a plastic film with microstructures thereon. Preferably, the substrate used in the method for manufacturing a microstructure transfer medium is coated with adhesion promoter to assist in adhering the release resin on the substrate.

For example, the method for manufacturing a microstructure transfer medium uses the following steps. At first, a polyethylene terephthalate (PET) substrate. The substrate is coated with adhesion promoter for ultraviolet curable resins. The adhesion promoter, such as solvent type silicone resin, helps the ultraviolet curable silicone resin adhere to the substrate. Then, a metallic mold is provided to use as the template of the microstructures, that are, for example, prisms. Certainly, the metallic mold can have a microlens, or Fresnel lens structure. The release resin is selected to be the ultraviolet curable silicone resin. The ultraviolet curable silicone resin can be acrylic type, epoxy type, or mercapto type silicone. The metallic mold is pressed into the ultraviolet curable silicone resin on the substrate. After radiated by the ultraviolet light, the substrate is separated from the metallic mold. The microstructure transfer medium is thus formed. The intensity of the ultraviolet light is about 20˜50 mW/cm².

The microstructure film or sheet fabricated by using the microstructure transfer medium according to the invention comprises: a first substrate having a first surface and a second surface; and a plurality of first microstructures formed on the first surface of the first substrate and made by using a first microstructure transfer medium. The first microstructure transfer medium comprises a second substrate and a release layer formed on the second substrate and the release layer has a template of the first microstructures thereon.

Furthermore, a plurality of second microstructures can be formed on the second surface of the first substrate by using a second microstructure transfer medium. The second microstructure transfer medium comprises a second substrate and a release layer formed on the second substrate and the release layer has a template of the second microstructures thereon.

For example, the method for fabricating the above microstructure film or sheet by using the microstructure transfer medium according to the invention comprises the following steps. At first a plastic substrate, such as PET film, is provided. The microstructure transfer medium has a template of the first microstructures and the release surface. Then, the microstructure transfer medium is laminated with the plastic substrate where the ultraviolet curable resin is provided between the microstructure transfer medium and the plastic substrate. The ultraviolet curable resin is acrylic or methacrylic resin, that can comprise mono-, bi-, and/or tri-functional acrylic or methacrylic monomers. The laminate is radiated with ultraviolet light, having the intensity of 20˜50 mW/cm² and a maximum wavelength of 365 nm. Finally, the laminate is separated into the microstructure transfer medium and the microstructure film with the first microstructures.

In addition, for example, the first substrate is a polymethyl methacrylate plate. The first microstructures are microlenses (flat convex or concave lenses). A light guide plate can be fabricated according to the above mentioned method using the microstructure transfer medium according to the invention. Furthermore, the above mentioned method using the microstructure transfer medium according to the invention can be utilized to fabricate a brightness enhancement film, diffusion film, diffusion sheet, microlens array film or sheet, Fresnel lens, etc.

In another preferred embodiments, the present invention provides a microstructure film, comprising: a first substrate having a first surface and a second surface and a plurality of first microstructures formed on the first surface of the first substrate and made by using a mold that is a laminate of a first microstructure transfer medium and a film having a plurality of third microstructures thereon. The first microstructure transfer medium comprises a second substrate and a release layer formed on the second substrate and the release layer has a plurality of second microstructures thereon. Preferably, the second substrate is a flexible film. The first microstructures comprise the third microstructures and the second microstructures. Therefore, the complicate microstructure can be easily formed.

Furthermore, the microstructure transfer medium according to the invention can also be utilized in the semiconductor or flat panel display process, such as fabricating an insulator layer. At first, the above method using the microstructure transfer medium is used to form a microstructure layer on a wafer or glass substrate. Plasma etching is carried out to obtain the insulator layer with the required patterned, on which the microstructures are formed.

To sum up, the present invention discloses a microstructure transfer medium to be utilized in fabricating various microstructure films. The microstructure transfer medium can be applied in manufacturing a variety of optical films of a backlight module, light guide plates, color enhancement film for liquid crystal displays, various patterned nanoimprint for semiconductor or flat panel display processes, and Fresnel lens.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims. For example, an adhesive layer can be on the surface opposing to the surface having the microstructures for adhering on an object.

What is claimed is:

1. A microstructure transfer medium, comprising:
a substrate; and
a release layer formed on the substrate wherein the release layer has microstructures thereon.

2. The medium according to claim 1, wherein the substrate is a film or sheet formed by the substance selected from a group consisting of the following: polyethylene terephthalate, polybutylene terephthalate, polyethylene naphthalate, polycarbonate, polyethylene, polypropylene, polystyrene, triacetyl cellulose, acrylate, methacrylate, and polyethylene chloride.

3. The medium according to claim 1, wherein the substrate is a film or sheet formed by polyethylene terephthalate.

4. The medium according to claim 1, wherein the surface energy of the release layer is lower than 30 dyne/cm.

5. The medium according to claim 1, wherein the release layer is formed by the substance with low surface energy selected from a group consisting of the following: silicone resin, fluorine-containing resin, and polyolefin resin.

6. The medium according to claim 1, wherein the microstructure is a hollow structure selected from a group consisting of the following: sphere, hemi-sphere, hemi-cylinder, prism, pyramid and the combination thereof and the microstructure forms a linear-, matrix-, or random-type three-dimensional pattern on the surface of the release layer.

7. The medium according to claim 1, wherein the microstructure is used to form the structure selected from a group consisting of the following: microlens, prism, hemi-cylinder, Fresnel lens, pyramid and combination thereof.

8. A method for manufacturing a microstructure transfer medium, comprising the following steps:
providing a substrate;
providing a mold having a template of the microstructure on the surface thereof;
coating a release resin on the substrate;
pressing the mold into the substrate having the release resin thereon and setting the release resin; and
separating the mold from the substrate to form the microstructure transfer medium.

9. The method according to claim 8, wherein the release resin is ultraviolet curable silicone resin.

10. The method according to claim 8, wherein the method for setting the release resin uses ultraviolet light to cure the release resin.

11. The method according to claim 8, wherein the mold is made of metals or plastics.

12. The method according to claim 8, wherein the mold is a photo-mask made by photolithography or laser ablation.

13. The method according to claim 8, wherein the substrate is coated with adhesion promoter for assisting in adhering the release resin on the substrate.

14. The method according to claim 8, wherein the mold is made of metals and produced by precision diamond turning or electroplating/electroforming.

15. A light guide plate, having a light exiting surface, the light guide plate comprising:
a plurality of microstructures formed on the light exiting surface, the surface opposing to the light exit surface, or both surfaces by using a microstructure transfer medium;
wherein the microstructure transfer medium comprises a substrate and a release layer formed on the substrate and the release layer has a template of the microstructures thereon.

16. A microstructure film, comprising:
a first substrate having a first surface and a second surface; and
a plurality of first microstructures formed on the first surface of the first substrate and made by using a first microstructure transfer medium;
wherein the first microstructure transfer medium comprises a second substrate and a release layer formed on the second substrate and the release layer has a template of the first microstructures thereon.

17. The microstructure film according to claim 16, further comprising: a plurality of second microstructures formed on the second surface of the first substrate and made by using a second microstructure transfer medium.
wherein the second microstructure transfer medium comprises a second substrate and a release layer formed on the second substrate and the release layer has a template of the second microstructures thereon.

18. The microstructure film according to claim 16, wherein the first microstructure is selected from a group consisting of the following: microlens, prism, hemi-cylinder, Fresnel lens, pyramid and combination thereof.

19. The microstructure film according to claim 16, wherein the second microstructure is selected from a group consisting of the following: microlens, prism, hemi-cylinder, Fresnel lens, pyramid and combination thereof.

20. The microstructure film according to claim 16, wherein the microstructure film is a brightness enhancement film.

21. The microstructure film according to claim 16, wherein the microstructure film is a diffusion film.

22. The microstructure film according to claim 16, wherein the microstructure film is a Fresnel lens.

23. The microstructure film according to claim 16, wherein the microstructure film is a microlens array film.

24. An insulator layer, comprising: a layer formed by using a microstructure transfer medium.
wherein the microstructure transfer medium comprises a substrate and a release layer formed on the substrate and the release layer has a template of insulator pattern thereon.

25. A microstructure film, comprising:
a first substrate having a first surface and a second surface; and
a plurality of first microstructures formed on the first surface of the first substrate and made by using a mold that is a laminate of a first microstructure transfer medium and a film having a plurality of third microstructures thereon;
wherein the first microstructure transfer medium comprises a second substrate and a release layer formed on the second substrate and the release layer has a plurality of second microstructures thereon.

26. The microstructure film according to claim 25, wherein the method of using the mold to form the first microstructures comprises: overlapping the first microstructure transfer medium and the film having a plurality of third microstructures thereon to form the mold; coating a resin on the first substrate; and pressing the mold into the first substrate coated with the resin and curing the resin to form the microstructure film.

27. The microstructure film according to claim 25, wherein the second substrate is a flexible film.

28. The microstructure film according to claim 25, wherein the first microstructures comprise the third microstructures and the second microstructures.

29. The microstructure film according to claim 25, wherein the third microstructure is selected from a group consisting of the following: microlens, prism, hemi-cylinder, Fresnel lens, pyramid and combination thereof.
